(19) United States
(12) Patent Application Publication
(10) Pub. No.: US 2026/0257137 A1
(43) Pub. Date: Sep. 3, 2026

(54) METHOD AND APPARATUS FOR CREATING A NON-PLAYER CHARACTER IN A COOPERATIVE VIDEO GAME AND METHOD AND APPARATUS FOR GENERATING A PLAYER PROFILE IN A COOPERATIVE VIDEO GAME

(71) Applicant: Sony Group Corporation, Tokyo (JP)

(72) Inventor: Rik CLAESEN, Stuttgart (DE)

(73) Assignee: Sony Group Corporation, Tokyo (JP)

(21) Appl. No.: 19/155,701

(22) PCT Filed: Mar. 12, 2024
(86) PCT No.: PCT/EP2024/056566

§ 371 Date: Aug. 12, 2025

(30) Foreign Application Priority Data
Mar. 17, 2023 (EP) 23162708.4

(51) Int. Cl. A63F 13/67; A63F 13/71; A63F 13/73; A63F 13/75; A63F 13/79

(52) U.S. Cl. CPC A63F 13/67; A63F 13/71; A63F 13/73; A63F 13/75; A63F 13/79

(57) ABSTRACT

The present disclosure relates to a method for creating a Non-Player Character, NPC, in a cooperative video game. The method comprises accessing, based on a user input of a user, a dataset representing a player profile of a human player of the cooperative video game. The player profile includes a set of attribute values indicating a playing behavior of the human player. The method further comprises creating the NPC based on the set of attribute values.

### FIELD

The present disclosure relates to cooperative video games. In particular, examples of the present disclosure relate to a method and an apparatus for creating a non-player character (NPC) in a cooperative video game and a method and apparatus for generating a dataset representing a player profile of a human player of a cooperative video game.

### BACKGROUND

A cooperative (co-op) video game is a video game that allows players to work together as teammates, which may be against NPC opponents. Popular examples are first-person shooting games and role-paying games. Playing the co-op video game simultaneously allows players to assist one another in many ways. However, not every player is keen on interacting with live players while playing. This may be for many reasons, which may include varying desires for social interaction or difficulty in finding commonly available times. To address this, companion co-op NPCs can be used.

Nevertheless, co-op games typically offer a player a limited choice of co-op NPCs to choose from. There may also be a problem with the configuration of the co-op NPCs. The co-op game software prepares scripted actions for a co-op NPC in response to a player's actions or situations in the game. In general, the NPCs in co-op games are strictly scripted, predictable, and limited in choices, thereby reducing their usefulness substantially. While some co-op video games offer co-op NPCs with parameters evolving during gameplay, the NPCs may still be limited in playing capabilities. For a seasoned player, such co-op NPCs are still too predictable and remain a source of frustration. This is especially the case when the co-op NPCs are led to a situation for which no scripted solution has been prepared or if generic solutions are applied in unpredictable circumstances.

Thus, there is a demand for creating higher quality NPCs, particularly NPCs with playing skills comparable to human players, in co-op video games.

### SUMMARY

This demand is met by a method and an apparatus for creating an NPC in a co-op video game, a method and an apparatus for generating a dataset representing a player profile of a human player of a co-op video game, a program, and a non-transitory machine-readable medium according to the independent claims. Advantageous embodiments are addressed by the dependent claims.

According to a first aspect, the present disclosure proposes a first method for creating an NPC in a co-op video game. The first method comprises accessing, based on a user input of a user, a dataset representing a player profile of a human player of the co-op video game. The player profile includes a set of attribute values indicating a playing behavior of the human player. The first method further comprises creating the NPC based on the set of attribute values.

According to a second aspect, the present disclosure proposes a second method for generating a dataset representing a player profile of a human player of a co-op video game. The second method comprises determining one or more behaviors indicating a playing behavior of the human player based on gaming data of the co-op video game. The second method further comprises determining, based on the one or more determined behaviors, a set of attribute values for predefined attributes. The predefined attributes are used by the co-op video game for creation and/or control of NPCs. Furthermore, the second method comprises generating the dataset to include the determined set of attribute values.

According to a third aspect, the present disclosure proposes an apparatus for creating an NPC in a co-op video game. The apparatus comprises processing circuitry configured to access, based on a user input of a user, a dataset representing a player profile of a human player of the co-op video game. The player profile includes a set of attribute values indicating a playing behavior of the human player. The processing circuitry is further configured to create the NPC based on the set of attribute values.

According to a fourth aspect, the present disclosure proposes an apparatus for generating a dataset representing a player profile of a human player of a co-op video game. The apparatus comprises processing circuitry configured to determine one or more behaviors indicating a playing behavior of the human player based on gaming data of the co-op video game. The processing circuitry is also configured to determine, based on the one or more determined behaviors, a set of attribute values for predefined attributes. The predefined attributes are used by the co-op video game for creation and/or control of NPCs. The processing circuitry is further configured to generate the dataset to include the determined set of attribute values.

According to a fifth aspect, the present disclosure proposes a program having a program code for performing at least one of the methods described above, when the program is executed on a processor or a programmable hardware.

According to a sixth aspect, the present disclosure proposes a non-transitory machine-readable medium having stored thereon a program having a program code for performing at least one of the methods described above, when the program is executed on a processor or a programmable hardware.

### BRIEF DESCRIPTION OF THE FIGURES

Some examples of apparatuses and/or methods will be described in the following by way of example only, and with reference to the accompanying figures, in which

FIG. 1 schematically illustrates an exemplary apparatus for creating an NPC in a co-op video game;

FIG. 2 schematically illustrates another exemplary apparatus for creating an NPC in a co-op video game;

FIG. 3 schematically illustrates another exemplary apparatus for creating an NPC in a co-op video game;

FIG. 4 illustrates a flowchart of an exemplary method for creating an NPC in a co-op video game; and

FIG. 5 schematically illustrates an exemplary apparatus for generating a dataset representing a player profile of a human player of a co-op video game;

FIG. 6 schematically illustrates another exemplary apparatus for generating a dataset representing a player profile of a human player of a co-op video game;

FIG. 7 illustrates a flowchart of an exemplary method for generating a dataset representing a player profile of a human player of a co-op video game.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

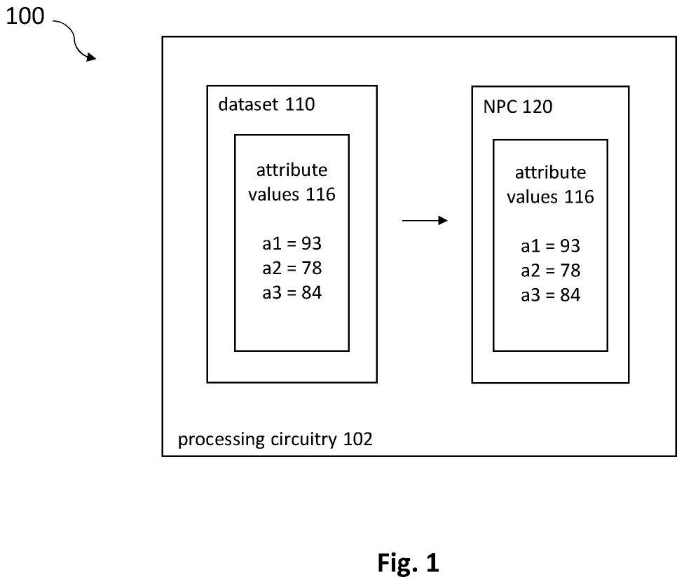

FIG. 1 schematically illustrates an exemplary apparatus for creating an NPC 120 in a co-op video game.

A co-op video game is a video game that allows human players to collaboratively play a game as player characters, usually against pre-programmed opponents known as NPCs. Multiple human players may play the co-op video game together to assist one another in various ways. For example, they may pass weapons or items to one another, assist each other in battles, and perform cooperative maneuvers. To maintain an identity and progress in a co-op video game, a player character played by a human player may maintain a corresponding player profile.

Co-op video games may also be played with NPCs as teammates, or co-op NPCs, each of which may correspond to an NPC profile. NPCs are characters that are not controlled by a human player are usually pre-programmed by the video game developers. Being pre-programmed, NPCs usually exhibit predictable behavior and limited skills. In order to improve a choice of co-op NPCs, a new NPC may be created or an existing NPC may be updated via re-programming based on playing behaviors or playing styles of a human player.

A human player, particularly an advanced human player, may perform more complicated actions related to the co-op video game. For example, an advanced human player may perform complex movements or use a complex combination of weapons. An advanced human player may also better collaborate with other players playing as player characters to achieve a common goal, particularly when collaboration requires efficient communication. If gaming data based on the gaming of a human player is generated while playing, then such gaming data may be analyzed to provide a basis for a creation of a co-op NPC with more realistic and advanced playing behavior. Information can be extracted from a player profile that is based on a human player playing the co-op video game and that information can be imported to an NPC profile for a creation or re-programming of an NPC in the co-op video game.

As will be evident from the following description, the apparatus 100 allows to access a dataset 110 corresponding to a player profile. The dataset 110 may be a collection of data related to the player character in the co-op video game. The dataset 110 may include various datatypes, including text, numerical values, and images, among other datatypes. The dataset 110 may comprise recorded information of a player character that documents a playing history in the co-op video game.

In general, the player profile may represent a player character that is controlled by the human player in the co-op video game. In general, the player profile may be based on the human player maintaining a record of progress within the co-op video game. For example, the player profile may comprise information periodically saved into a memory in the co-op video game for the human player to access while playing. The player profile may evolve each time the human player is playing the co-op video game, based on actions and decisions of the human player.

Since there is a large degree of freedom for the human player to choose certain actions and decisions in co-op video games, playing behaviors may be a useful distinguishing feature between various player characters. In general, a playing behavior may describe tendencies related to the actions and decisions of the player character as played by the human player. By observing the actions and decisions of a player character over time, certain tendencies may be identified more often than others. These tendencies may thus be given a label associated with the player character in the form of an identifiable behavior. The following paragraphs provide examples of how identifiable behaviors may be labeled, particularly within a group of certain playing styles or adopted roles.

For example, a playing style may include being dominant, which may be a tendency to take initiative in assigning tasks to teammates. Another playing style may include being aggressive, such as moving straight toward a target in a shooting or fighting scenario and accepting collateral damage, or motivated, attempting to solve difficult problems requiring many steps. A player may also be collaborative, performing planned actions with teammates against opponents, or supportive, performing actions to enable another player to continue playing. Opposite forms of the above listed playing styles may also be used to describe a player profile. For example, in addition to describing behavior as aggressive, a player character may also be described as cautious, and in addition to describing behavior as motivated, a player character may also be described as lazy.

An adopted role may be a description of the player character embracing a specific function within a group dynamic. Such adopted roles may include a leader, where the player character often takes initiative in guiding and motivating teammates. Another role may be strategist, where the player character specializes in forming creative solutions by organizing multiple players. Another role may be communicator, where the player character specializes in communicating large amounts of information to multiple players. Roles particular to fighting co-op video games include the healer role, where the player character specializes in healing injuries of teammates, and the tank role, where the player character tries to absorb damage from opponents to protect teammates. Adopted roles may also describe how a player character fails to provide a useful function within a group. Roles less desired for teammates in co-op video games may include loner, where the player character primarily acts in self-interest or self-preservation, leecher, where the player character mostly relies on others to do work while contributing little themselves, and saboteur, where the player character deliberately works against the team's objectives or strategies.

The large degree of freedom for the actions and decisions of human players in the co-op video game may lead to great variability within a particular behavior. For example, a player character may often exhibit an aggressive playing behavior, but in controlled ways within a team strategy. Another player character may exhibit the same amount of aggressive behavior, but less controlled and against the wishes of teammates. Such an example illustrates the many various ways of how it may be useful for a behavior to be described in more detail. For this, each indicated playing behavior of the player character may have certain linked attributes assigned to it. The attributes may express characteristics of the player character represented by the player profile more accurately.

To provide a more precise description of the player character, the dataset 110 comprises attributes that are associated with one or more playing behaviors of the human player. While playing behaviors of the player character may relate to observable actions and decisions, attributes may describe inherent aspects that may be representative of an identity of the player character as played by the human player. More specifically, a behavior may be influenced by multiple factors. This may include characteristics (or features or qualities) of the player character as played by the human player, but may also include circumstances or contexts within the co-op video game. The various factors may each influence a behavior of the player character by different amounts for each instance of the behavior. Thus, playing behaviors may be inadequate for accurately or precisely describing the player character.

On the other hand, an attribute may be an inherent characteristic, feature, or quality representative of the player character's identity and may be a more fundamental description of the player character as played by the human player. In other words, attributes of a player character may either be fixed or unlikely to change over time. The attributes of a player character may be chosen from a set of pre-defined attributes determined specifically for the co-op video game. The predefined attributes may attributes that are relevant in the context of playing the co-op video game. For example, depending on the co-op video game, the predefined attributes for player characters may specifically relate to skills required for playing, such as shooting weapons, fighting movements, and/or spells, potions, or mana, among others. The predefined attributes may relate to personality traits to the applying such skills, such as how weapons are used, enemies are fought, or how spells or potions are used.

To describe the inherent characteristics related to the attributes accurately and precisely, each attribute may be assigned an attribute value. An attribute value may represent a certain amount or degree of how much the corresponding attribute matches the player character. An attribute value may comprise a quantitative evaluation of how much a player character matches a specific predefined attribute relative to other player characters and NPCs. Beyond playing behaviors, the set of attributes and attribute values 116 may allow a more specific and precise description of a player character in the co-op video game.

The dataset 110 in FIG. 1 is depicted to comprise a set of attribute values 116 for three attributes a1, a2, and a3, with corresponding attribute values of 93, 78, and 84. The three attributes and attribute values provide a representation of the set of attribute values 116, which may be arbitrarily long, such that the set of attribute values 116 may sufficiently specify characteristics of a corresponding player character in the co-op video game. The dataset 110 may comprise further information describing how the attribute values affect the performance of an NPC created based thereon.

The dataset 110, comprising information to specify many characteristics of a player character, may provide a basis for a creation of an NPC 120 in the co-op video game. The apparatus 100 is configured to access the dataset 110 and to create an NPC 120 based on the dataset 110. For accessing the dataset 110 and creating the NPC 120, the apparatus comprises processing circuitry 102. The processing circuitry 102 may take multiple forms. For example, the processing circuitry 102 may be a single dedicated processor, a single shared processor, or a plurality of individual processors, some of which or all of which may be shared. Alternatively, the processing circuitry 102 may be a digital signal processor (DSP) hardware, an application specific integrated circuit (ASIC), a neuromorphic processor or a field programmable gate array (FPGA). The processing circuitry 102 may optionally be coupled to, e.g., read only memory (ROM) for storing software, random access memory (RAM) and/or non-volatile memory. Optionally, the apparatus 100 may comprise further circuitry.

The processing circuitry 102 accessing the dataset 110 may include retrieving the dataset 110 from a storage location and making it available to a program for further use. The storage location may be a storage device in the apparatus 100, such as a hard drive or solid state drive. The storage location may also be external to the apparatus 100, such as a cloud storage or server connectable to the apparatus 100 via a network. Accessing the dataset 110 may include specifying a path of the dataset 110 to the storage location. Specifying the path may include providing the location of the dataset 110 and providing a means for a user or automated process through a series of drives and/or folders. For example, if the dataset is stored in a file, then the path may include the location of the file within a series of drives and/or folders, as well as the name and file extension of the file.

Accessing the dataset 110 may include methods of retrieving the dataset 110 more quickly, such as by specifying an identifier that uniquely identifies the dataset 110. For example, a unique identifier assigned to the dataset 110 may be maintained in a database that is organized to expediate retrieving files. Beyond retrieving the dataset 110, accessing the dataset may also include meeting certain conditions required for reading the dataset 110. Such conditions may include providing necessary permissions to read the dataset 110 and using a specific software application to open and read the dataset 110.

Once the dataset 110 has been accessed, the processing circuitry 102 may be configured to create the NPC 120 based thereon. To newly create an NPC 120, the processing circuitry may be configured to integrate the NPC 120 into the co-op video game engine. This may include programming a presence of the NPC 120 in the co-op video game world. To enable the NPC to interact with an environment of the co-op video game world, the processing circuitry 102 may use programming related to collision detection, pathfinding, decision-making, animation, dialogue trees, and/or event handling.

The dataset 110 may comprise information to be added to various programming for a traditional NPC. For example, dialogue trees that may have been written for a traditional NPC may have added thereto many further possibilities of dialogue for the created NPC 120. Furthermore, the event handling of the NPC 120 may be programmed to exhibit more specific behaviors based on events in the co-op video game. The NPC may be programmed to perform actions or decisions specifically in response to many possible actions and decisions of player characters played by a human player or other NPC characters.

The NPC 120 may be generated either as a newly created NPC or as a re-programmed NPC that was already programmed into the co-op video game world. The re-programmed NPC may have had certain programmed aspects added and/or re-written to a traditional NPC programming based on the dataset 110. For example, the attribute values 116 may comprise information related to specific attributes that correspond to a specific programming related to the NPC 120, such as decision-making, dialogue trees, and event handling, among others.

Once the NPC 120 has been created or re-programmed, the processing circuitry 102 may be configured to cause the video game to control the NPC based on the set of attribute values 116. In other words, the programming associated with the NPC 120 that was created or re-programmed based on the attribute values 116 may then be manipulated by the video game (game engine) for the NPC to behave according to the attribute values under the corresponding circumstances. The behaviors of the player character as played by the human player may be mapped to predefined attributes and assigned corresponding attribute values, which may then be used in programming behaviors of an NPC corresponding to the attribute values.

As previously outlined, traditional NPCs may exhibit predictable behaviors. For example, in response to certain situations, a traditional NPC may have a small range of actions and decisions that may be taken. Thus, a traditional NPC may often exhibit predictable behavior, which may leave the player character of the human player more vulnerable to enemies in the co-op video game. Furthermore, the dialogue of the traditional NPC may also be limited, limiting the amount of help that can be offered to the player character, particularly in unpredictable circumstances.

The NPC 120 based on the dataset 110, on the other hand, is derived from a player character as played by a human player. A human player may consider more complex information when choosing a certain action or decision and may thus control a corresponding player character in more complex ways. The attributes and attribute values in the dataset 110, as derived from the player character of the human player, may enable the created NPC 120 to perform more complex actions and make decisions based on a wider range of information. The created NPC 120 may thus respond to specific and unpredictable situations in a way that may be similar to how the human player may respond. The dialogue of the created NPC 120 may also provide more valuable information or insight related to an unpredictable situation in ways comparable to the human player.

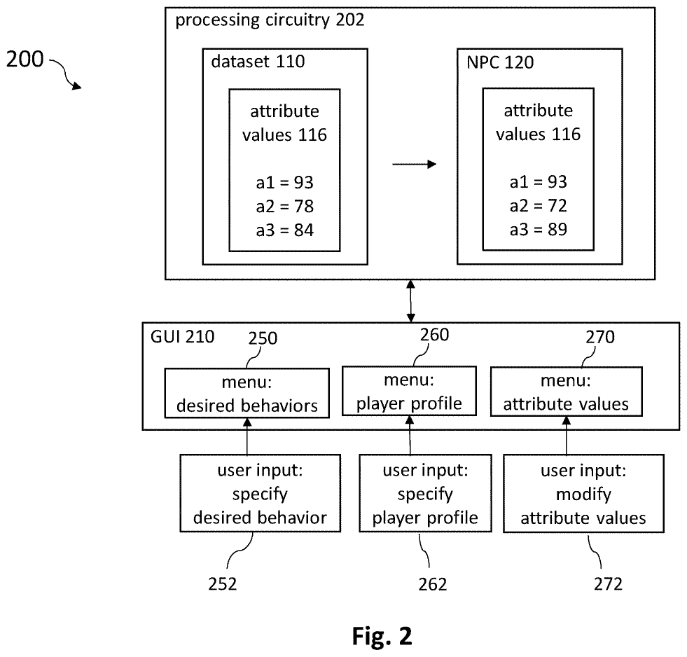

Creating an NPC 120 with behaviors comparable to a human player may still leave a user of the apparatus 100 not completely satisfied with the co-op gaming experience. Certain playing behaviors of a human player may not adequately match the desires of a user for specific playing behaviors. This may lead the user to desire an NPC with other behaviors or more specified behaviors. In further embodiments of the apparatus 100, the processing circuitry 102 may be configured to provide a greater choice of datasets, each comprising a unique set of desired behaviors for a co-op NPC 120. For example, the apparatus 100 may be configured to provide access to multiple datasets comprising different attribute values for indicated behaviors. The apparatus 100 may further be configured to enable choosing an optimal dataset out of the multiple datasets for a more personalized co-op gaming experience. Such features may be included in a further embodiment of the apparatus 100, which will be described in the following with reference to FIG. 2.

FIG. 2 illustrates GUI functions of a second exemplary apparatus 200 for creating an NPC 120 in a co-op video game. The apparatus 200 is based on the apparatus 100 described above and may be understood as an extension of the apparatus 100 providing the below described additional functionalities.

The apparatus 200 comprises processing circuitry 202 configured to create the NPC 120 based on the set of attribute values 116. The processing circuitry 202 may take various forms, including those previously outlined for the apparatus 100 in FIG. 1. The processing circuitry 202 may be configured to cause output of a graphical user interface, GUI 210, which may allow a user to specify and access the dataset 110 representing the player profile. To help the user find the dataset 110, the GUI 210 may include a search functionality feature, such as a search bar that allows the user to search for specific data based on keywords and filters. The GUI 210 may further include features related to filter and sort options that allow sorting based on different criteria, such as data, location, or category.

To aid the user in finding a dataset for an NPC more suitable to the user's abilities or preferences, the GUI 210 may be configured to display a menu of desired behaviors 250 for a co-op NPC. The apparatus 200 may comprise a list of identifiable behaviors and may be configured to present the identifiable behaviors via the GUI 210 to the user. In response, the user may provide a user input 252 to specify one or more desired behaviors out of the list of identifiable behaviors. For example, within the behaviors previously described for FIG. 1, an experienced player may wish to obtain a dataset for an NPC that is more collaborative, while a less experienced player may wish to obtain a dataset for an NPC that is more dominant. The list of identifiable behaviors in the menu of desired behaviors 250 may be formed based on information provided by developers or experienced players of the co-op video game. The information may also be derived from an analysis of gaming data of the co-op video game that may have been used to generate one or more of the datasets.

In response to the user input 252 of desired behaviors, the GUI 210 may provide a menu of player profiles 260. Each player profile may represent a dataset that comprises some or all of the desired behaviors. Since each dataset may be generated based on a mix of behaviors that may not fully match the desired behaviors of the user, the processing circuitry 202 may be configured to apply thresholds to select player profiles for display. The processing circuitry 202 may be configured to enable the user to manually adjust the thresholds based on a user wish to expand or shrink the number of player profiles displayed. The processing circuitry 202 may further be configured to display to the user a description, attributes, and/or attribute values related to one or more desired behaviors for each visible player profile.

For example, a user may wish to obtain a dataset corresponding to dominant behavior of a player character. The dominant behavior for a player profile may be associated with attributes related to organization and communication. One form of dominant behavior may be related to a player character that takes more time to communicate with teammates in the co-op video game to organize a fighting strategy. The dominant behavior would then be associated with higher attribute values related to organization and communication. Another form of dominant behavior may be related to a player character being less communicative and limiting group discussion related to strategy. Such a dominant behavior would then be associated with lower attribute values related to organization and communication but may be desired by the user to spend less time collaborating while playing. In this particular case, the user may see multiple player profiles related to dominant behavior and how other attributes relate to the dominant behavior. The displayed descriptions, attributes, and/or attribute values may enable the user to make an optimal choice for a player profile within a large group of player profiles. The GUI 210 may further be configured to receive a user input 262 to specify the player profile. In response to such a user input 262, the processing circuitry 202 may be configured to display and provide access to a corresponding dataset representing the specified player profile.

Beyond finding a dataset for an NPC with specific desired behaviors among a choice of multiple datasets, such features of the apparatus 200 may still be inadequate for advanced players. The user may wish to further adapt qualities of the NPC 120. For this, the GUI 210 may further comprise a menu of attribute values 270 corresponding to a player profile that has been selected for creating an NPC. The menu of attribute values 270 may display to the user attributes with modifiable attribute values and the GUI 210 may be configured to receive a user input 272 to modify the attribute value for one or more attributes. Continuing with the previous example, the user may modify how communicative the NPC 120 is in relation to a dominant behavior based on a preference of how much the user generally wants to discuss strategy while playing. A very experienced player may wish to lower such an attribute value even further or a very inexperienced player may wish to raise it.

For modifying the attribute values, the menu of attribute values 270 may comprise one or more graphical elements that may be manipulated by the user. For example, the GUI 210 may provide a slide interface, which may be in the form of a slider control in a slide bar. The slide bar may comprise a value display, tick marks, and/or labels of maximum or minimum values, among other features. The GUI 210 may also provide modifiable graphical elements in other forms, such as drop-down menus, text boxes, buttons, and/or a circular dial, among other forms.

Based on the user input 272 to modify the set of attribute values 116, the apparatus 200 may be configured to create the NPC 120 based thereon. The apparatus 200 may then cause the co-op video game to control the NPC 120 based on the modified set of attribute values. The GUI 210 may be configured to restrict modification in the menu of attribute values 270 to a specific range in order to maintain the behaviors and attributes of the NPC 120 described in the corresponding NPC profile. In FIG. 2, attributes 2 and 3 are depicted as modified attributes with slightly altered attribute values of 72 (from 78) and 89 (from 84), respectively.

In addition to modifying attribute values for the NPC 120 before creation, the apparatus 200 may be configured to provide the user with the possibility of modifying the attribute values after creation as well. The GUI 210 may be configured to maintain the menu of attribute values 270 accessible to the user after creation of the NPC 120. The apparatus 200 may be configured to receive re-modified attribute values and either newly create the NPC 120 or re-program the NPC 120 based on the re-modified attribute values. As such, the user may periodically modify the attribute values for the NPC 120, which may provide a highly customized co-op gaming experience for the user.

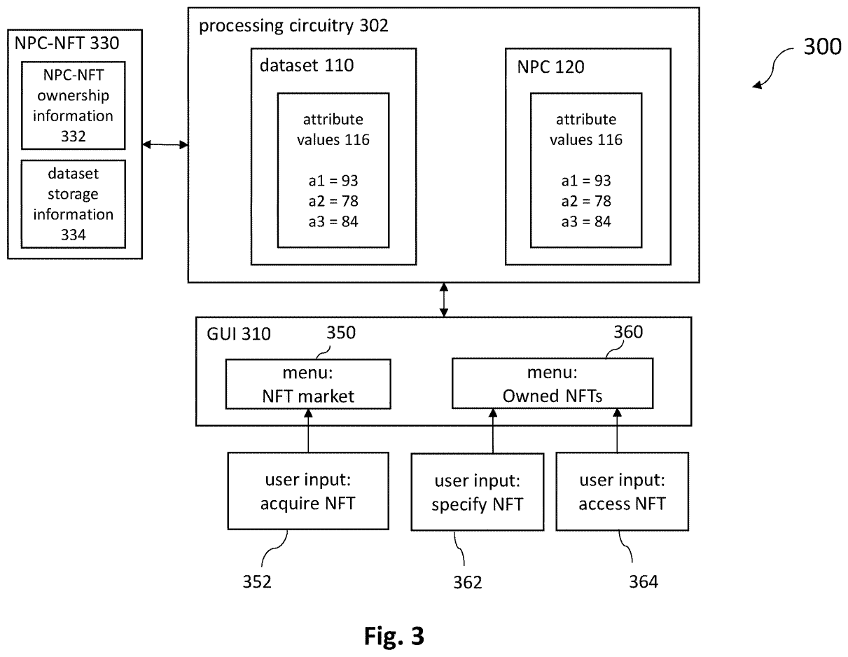

In order to provide easier access to a large selection of player profiles and corresponding datasets, the apparatus 100; 200 may comprise features that enable a connection to external networks and an ease of exchange of such datasets. A large number of player profiles may be generated for a system of exchange that includes incentives for generation, as well as security for the datasets. The described features may be provided through the use of blockchain technology, particularly using non-fungible tokens, NFTs, on blockchain technology networks. Further features related to the GUI 210, including features related to NFTs and blockchain technology, will be given in the following with reference to FIG. 3.

FIG. 3 illustrates further GUI functions of another exemplary apparatus 300 for creating an NPC in a co-op video game. The apparatus 300 is based on the apparatus 100, 200 described above and may be understood as an extension of the apparatus 100, 200 providing the below described additional functionalities.

The apparatus 300 comprises processing circuitry 302 configured to cause output of a GUI 310 (analogous to the processing circuitry 202 and GUI 210 of FIG. 2). The apparatus 300 may be configured to connect to a blockchain network to provide access to a non-fungible token, NFT 330, that is owned by the user and resides on the blockchain network. The NFT 330 may represent ownership of the dataset 110 for creation of the NPC 120. As such, the NFT 330 may also be referred to as the NPC-NFT 330. The NPC-NFT 330 may comprise ownership information 332 indicating ownership of the dataset 110. The ownership information 332 may be used to control access to a secure storage location of the dataset 110, which may prevent access to users who are not the owner of the NPC-NFT 330.

In general, an NFT is a unique, exchangeable digital asset that represents ownership of a specific item. An NFT may be “minted” by means of a blockchain technology, such as Ethereum, which creates a permanent link for the item to the digital asset. A minted NFT may comprise a smart contract that is permanently associated with the owned item. The minting process may involve creating a new block, validating information, recording the smart contract into the block, and adding the block into a blockchain network. The smart contract may include a cryptographic hash value (a unique string of letters and numbers) generated by a cryptographic hash function. The hash value may serve as a unique identifier for an NFT within the smart contract, and it may be saved in a unique digital file residing on the blockchain network.

While fungible assets are interchangeable or can be replicated, each NFT is unique and comprises ownership information verified by the blockchain technology. NFTs may only have one owner at a time, with the ownership of the item distinguished by the unique identifier. The single ownership of an NFT may be managed through the smart contract on the blockchain network, which may allow for easy transfer of ownership between parties. Once created, an NFT can be bought or sold on any NFT market accessing the blockchain network.

After purchasing an NFT, the ownership of that NFT can be transferred from a seller's digital wallet address to an owner's digital wallet address. This transfer of ownership may be recorded in the smart contract on the blockchain network. To verify the ownership information, an NFT is associated with a creator's public key and a unique private key associated with the NFT owner and the owner's digital wallet address. The ownership of the unique private key may be proven without revealing the private key to anyone else. The ownership may be demonstrated, for example, by using the private key to generate a digital signature to be attached to a signed message. Since the corresponding NFT is stored on the blockchain, the ownership can also be checked by anyone with access to the blockchain network by checking the ownership history.

The NPC-NFT 330 may further comprise storage information 334 indicating a storage location of the dataset 110 on the blockchain network. The apparatus 300 may be configured to connect to the blockchain network comprising the NPC-NFT 330 and to allow the user to specify the NPC-NFT 330 to access the storage location and read the dataset 110.

To restrict access to the storage location, the storage information 334 may be accessible to the user on the condition of an ownership verification in accordance with ownership information 332 of the NPC-NFT. The apparatus 300 may be configured to enable a user to verify ownership of the NPC-NFT 330 through a connection to the blockchain network where the NPC-NFT 330 resides. The apparatus 300 may also connect to the blockchain network via a blockchain explorer. While connected to the blockchain network, the GUI 310 of the apparatus 300 may prompt the user to sign a message with a digital signature using the private key of the NPC-NFT 330 and send the signed message to the blockchain network. The digital signature may be verified by the smart contract of the NPC-NFT 330. During verification, the GUI 310 may display information related to the smart contract of the NPC-NFT 330, which may include displaying a history of transactions and a transaction hash for the most recent transfer to the owner of the NPC-NFT 330. The GUI 310 may display a match between the digital signature and the owner of the NPC-NFT 330.

Based on a successful verification of ownership, the apparatus 300 may be configured to enable a user to access the storage location of the dataset 110. Digital assets of NFTs may usually reside on the same blockchain network, but it is also possible for the digital asset to be stored in a separate controlled database or file storage system. Thus, the storage information 334 may indicate a storage location of the dataset that is located in the blockchain network or separate from the blockchain network of the NPC-NFT 330. The apparatus 300 may be configured to receive the storage location from the storage information 334 from the NPC-NFT 330, access the storage location, and to read the dataset 110 from the storage location.

In addition to the features related to the NPC-NFT 330, the apparatus 300 may be configured to enable an ease of access to further NFTs. For example, the GUI 310 may comprise an NFT market menu 350. The GUI 310 may connect to a marketplace of a blockchain network with NFTs for sale and provide corresponding descriptions in the NFT market menu 350. The apparatus 300 may also be configured to connect to multiple blockchain networks or multiple blockchain explorers accessing a blockchain network. By means of a user input 352 to acquire an NFT, the user may specify an NFT that is for sale and then acquire the NFT. Once the NFT has been acquired, information related to the NFT may be stored in the apparatus 300 and accessible to the user via the GUI 310. The NFT market menu 350 may provide an ease of exchange of NFTs. In particular, a player of the co-op video game can conveniently buy and sell multiple NFTs related to further datasets for co-op video games. The further datasets may also provide information for creation of NPCs of co-op video games.

For example, the NFT market menu 350 may provide access to multiple NPC-NFTs, each corresponding to a dataset for creation of a co-op NPC in a co-op video game. Features of the NFT market menu 350 may be combined with the features of the menus 250; 260; 270 described in FIG. 2. The GUI 310 may be configured to enable the user to search multiple NFTs within the NFT market menu 350 for a player profile with particular desired behaviors. For example, the GUI 310 may comprise a search mechanism that the user may use within the NFT market menu 320A to browse the market more efficiently. The NFT market menu 320A may display information for an NPC-NFT in the player profile or elsewhere related to highly accomplished human players or celebrities with a following related to the co-op video game. This may include an amount of playing experience or achievements of the human player, as well as unique skills or playing styles within the co-op video game. For an NPC-NFT based on an accomplished human player (or any human player), the NFT market menu 320A may display video highlights of the corresponding player character as played by the human player in the co-op video game. This may allow the user to gain a better understanding of how an NPC with such skills and/or playing styles corresponding to those displayed for the NPC-NFT may be helpful or interesting while playing the co-op video game.

Once a desired player profile is found, the GUI 310 may be configured to enable the user to specify a player profile and to enable the user to acquire (purchase) the NFT corresponding to the player profile via the NFT market menu 350. Thus, the GUI 310 may aid the user in finding an optimal player profile with desired behaviors and to acquire a corresponding NFT more efficiently.

For the case that no NFT exists for behaviors of an NPC that match a user's demands, the GUI 310 may be further configured to provide a user feedback for future generation of NFTs. For example, the user may provide a list of desired behaviors to the NFT market menu 350, which may motivate another user to generate a dataset matching such behaviors.

For the case that the user owns many NFTs, the GUI 310 may further comprise a menu of owned NFTs 360, which may provide of list of NFTs owned by the user. For the user who owns the NPC-NFT 330 of the dataset 110, the NPC-NFT 330 may appear in the menu of owned NFTs 360. The user may provide a user input 362 to the owned NFTs menu 360 to specify the NPC-NFT 330, and in response, the GUI 310 may be configured to verify the ownership information 332 in order to access the dataset 110 (as previously described). Upon verification, the apparatus 300 may be configured to create the NPC 120 for use in the co-op video game.

The menu of owned NFTs 360 may enable the user to conveniently access each dataset corresponding to an owned NFT and to make a corresponding NPC. The processing circuitry 302 may provide information of an owned NFT to the menu of owned NFTs 360 for an ownership verification. The information may be related to the smart contract, such as the contract address, contract code, and history of transactions for the corresponding NFT. The processing circuitry may further be configured to verify ownership of the NFT without a manual user input. For example, the processing circuitry may be configured to automatically apply a corresponding private key that serves as a unique identifier for the NFT through a unique digital signature, as previously described.

In case the user has acquired many NFTs corresponding to a dataset for creation of an NPC, the GUI 310 may be configured to provide the user with search functions to search for desired behaviors also within the menu of owned NFTs 360. The menu of owned NFTs 360 may thus enable the user to efficiently test multiple different NPC-NFTs in the co-op video game more efficiently.

The many features of the apparatus 100; 200; 300 may provide a new co-op gaming experience for a human player. The human player may be able to test playing the co-op video game with various co-op NPCs, each with human-like abilities and varied behaviors. With features for finding and organizing multiple datasets for the creation of multiple co-op NPCs, the time required to gain experience playing with the multiple co-op NPCs may be shortened. This may enable the human player not only to develop skills within the co-op video more quickly, but also to quickly broaden the experience of playing with different types of characters and gain new insights and perspectives related to the co-op video game.

Datasets representing a player profile of a human player of a co-op video game such as the dataset 110 described above may be generated in various ways. Such datasets may be generated by entities separate from the apparatuses 100, 200 and 300 described above. For example, a dataset representing a player profile of a human player of a co-op video game may be generated based on an analysis of gaming data of the co-op video game. In particular, the gaming behavior of the human player may be analyzed and be transferred (translated) into a player profile of a human player. In the following, an exemplary approach for generating dataset representing a player profile of a human player of a co-op video game will be described. It is to be noted that datasets such as dataset 110 accessed and used by the apparatuses 100, 200 and 300 for NPC generation may be generated, but need not be generated as described in the following.

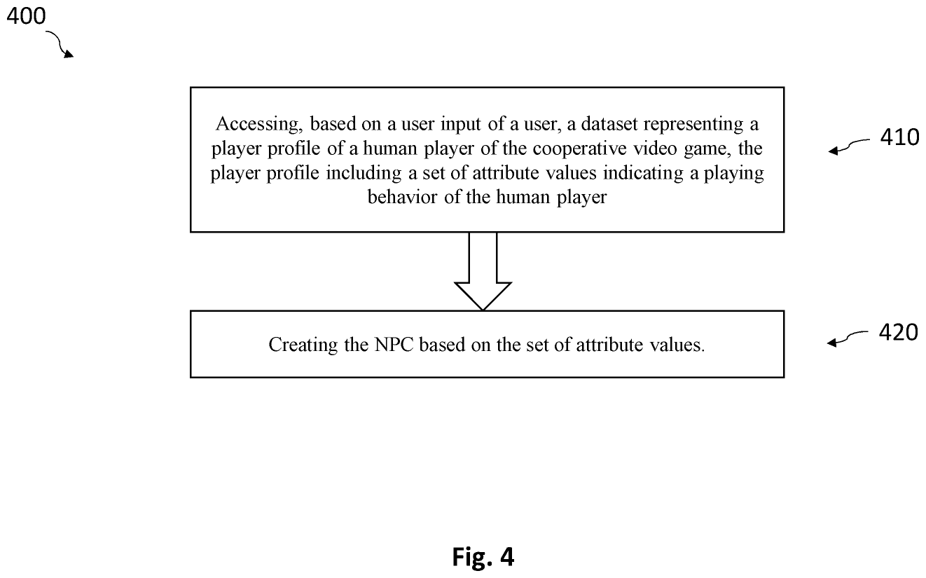

FIG. 4 illustrates a flowchart of an exemplary method 400 for creating an NPC in a co-op video game.

The method 400 comprises accessing 410, based on a user input of a user, a dataset representing a player profile of a human player of the co-op video game. The player profile includes a set of attribute values indicating a playing behavior of the human player. The method 400 further comprises creating 420 an NPC based on the set of attribute values. The method 400 may optionally comprise one or more further features described above (e.g. FIGS. 2 and 3).

As previously outlined, traditional NPCs may exhibit predictable behaviors with a small range of actions and decisions, limited dialogue, and limited help, particularly in unpredictable situations. The method 400 may provide multiple advantages over traditionally programmed NPCs. For example, the method 400 may enable the created NPC to perform more complex actions or make decisions based on a wider range of information. Furthermore, the method 400 may enable the dialogue of the created NPC to provide more valuable information or insight related to an unpredictable situation. Specifically, the method 400 may enable the created NPC to respond to unpredictable situations in a way that may be similar to how a human player may respond.

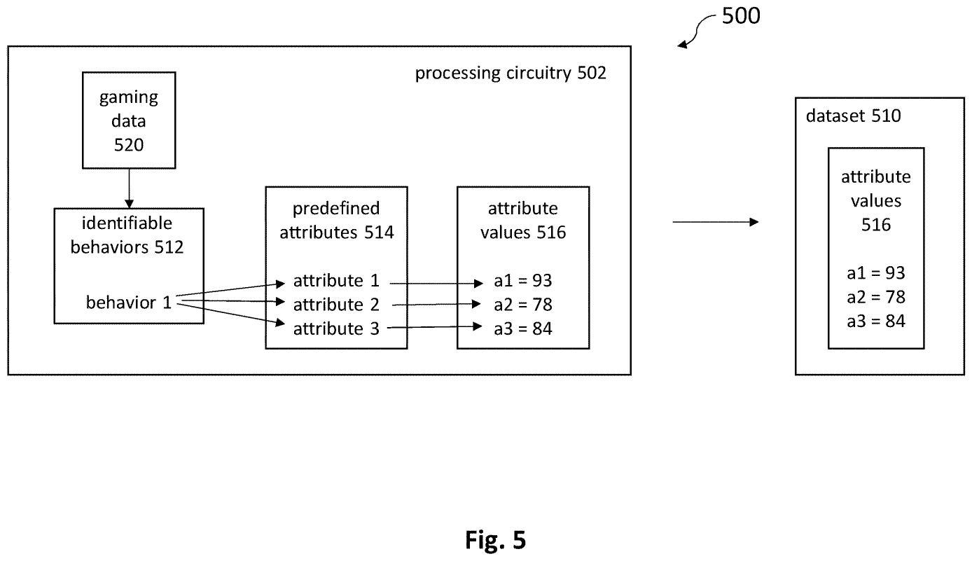

FIG. 5 schematically illustrates an exemplary apparatus 500 for generating a dataset 510 representing a player profile of a human player of a co-op video game.

The apparatus 500 comprises processing circuitry 502 configured to generate the dataset 510 based on gaming data 520. The dataset 510 may comprise information that is analogous to the dataset 110 previously outlined in FIG. 1. For example, the dataset 510 may be a collection of data related to a player character in the co-op video game. The dataset 510 may include various datatypes, including text, numerical values, and images, among other datatypes. The dataset 510 may comprise recorded information of a player character that documents a playing history in the co-op video game.

To generate the dataset 510, the processing circuitry 502 may include multiple processing components, including those described for the processing circuitry 102 described in FIG. 1. The apparatus 500 is configured such that the generated dataset 510 may comprise all features of the dataset 110 used for creation or re-programming of the co-op NPC 120, as described in FIG. 1. As such the apparatus 500 may serve a complementary function of the apparatus 100; 200; 300 in FIGS. 1 to 3.

The dataset 510 is based on the gaming data 520 of a player character as played by a human player in the co-op video game. The gaming data 520 may be any information related to the player character in the co-op video game that was recorded while the player character was played by the human player. The gaming data 520 may be derived from recorded information related to a player profile of the player character or from recorded video footage of the player character. The dataset 510 may be generated by performing an analysis of behaviors within the gaming data 520. If the behaviors of the player character as played by the human player are adequately analyzed, then it may serve the function of the apparatus 100; 200, 300 for creating or re-programming an NPC that may also exhibit human-like behavior. In particular, the NPC may exhibit specific behaviors that may distinguish it from other NPCs.

For generation of the dataset 510, the processing circuitry 502 is configured to determine more or playing behaviors based on the gaming data 520. As previously described, a playing behavior may describe tendencies and trends related to the actions and decisions of the player character. The actions and decisions related to a playing behavior may be influenced by inherent characteristics of a player character, as well as specific circumstances or contexts while the actions and decisions are performed. The gaming data 520 may comprise information related to many performed actions and decisions by the human player while playing the co-op video game. By observing the actions and decisions within the gaming data 520, certain tendencies and trends may be identified and labeled from a set of identifiable behaviors 512. Each identifiable behavior 512 may be mapped to certain attributes.

A selection of predefined attributes 514 may provide a common basis between the gaming data 520 with demonstrated behaviors related to the human player and the dataset 510 for creating or re-programming an NPC exhibiting the same behaviors. The predefined attributes 514 may be a list of possible qualities or characteristics used to describe player characters and NPCs that are relevant in the context of the co-op video game. To distinguish player characters by the selected attributes more precisely and accurately, each selected attribute may have assigned thereto a corresponding attribute value. The attribute value may represent a certain amount or degree of how much the corresponding attribute matches the player character. An attribute value may comprise a quantitative evaluation of how much a player character matches a specific predefined attribute relative to other player characters and NPCs.

In FIG. 5, an identifiable behavior (behavior 1) is depicted as being mapped to three predefined attributes (attribute 1, attribute 2, and attribute 3). The processing circuitry 502 is further configured to determine a set of attribute values 516 based on the gaming data 520. For example, if behavior 1 is an identified behavior of the gaming data 520, then the corresponding attributes 1, 2, and 3 may be assigned attribute values (93, 78, and 84, respectively), as depicted.

By assigning attribute values to the predefined attributes 514, the dataset 510 may comprise more specific information related to particular behaviors of the player character. An NPC based on the gaming data 520 may comprise not only human-like behaviors, but also distinguishable behaviors based on the player character. Such behaviors may include behaviors related to playing styles and adopted roles, as described in FIG. 1. In general, the identifiable behaviors 512 may describe categories of tendencies in performing certain actions and decisions of the player character as played by the human player.

As described in FIG. 1, playing styles may include being dominant, aggressive, motivated, collaborative, supportive, cautious, or lazy, among others. Adopted roles may include being a leader, strategist, communicator, healer role, tank role, loner, leecher, or saboteur, among others. The mix of playing style behaviors and adopted roles and how often each is demonstrated in the gaming data 520 may be analyzed to provide a list of behaviors within the identifiable behaviors 512 to be mapped to the predefined attributes 514. The predefined attributes 514 that correspond to the determined behaviors may then be assigned an attribute value based on the analysis, which may be recorded into the dataset 510.

The attribute values 516 for the mapped predefined attributes 514 may also evolve as the player continues playing the co-op video game. For example, by playing many hours, a player may develop finer skills and have more experience against particular opponents, which may also affect the personality or playing style of the player. The change in behaviors may then affect a new iteration of recorded gaming data, which may lead to new attribute values 516 for the predefined attributes 514 in a further iteration of the dataset 510.

The degree of a behavior demonstrated may directly or indirectly determine an attribute value for each predefined attribute. In particular, the predefined attributes 514 may relate to a skill, experience, or personality of the player character as played by the human player.

Skills may be a measure of ability to effectively and efficiently complete tasks or defeat opponents within the co-op video game. Examples of predefined attributes 514 related to skills of a player character may include agility, which may be a measure of being able to perform quick and precise body movements, dexterity, which may be a measure of being able to perform required actions from different angles or in different positions, accuracy, which may be a measure of ability in aiming and shooting weapons, and endurance, which may be a measure of how long a player can continuously make progress through the game in an uninterrupted time period. Skills may also relate to a special ability of a character, such as abilities related to magic, mana, or casting spells in fantasy co-op video games. Special abilities may be derived from the knowledge of the player or from an ability that is programmed for the character due to reaching a certain level, among other reasons. The skills described may derive from either the human player's abilities to control the player character and/or the programming of the player character enabling advanced abilities.

Experience may be a measure of skills based directly on a successful completion of a task or a failed attempt to do so. For example, experience may be related to knowledge of certain opponents based on previously playing against them. This may include knowledge of certain tactics, such as a timing of attacking or defending. Attributes related to experience may be characteristics of a player that are only possible after many hours of playing, such as creativity, which may be a measure of completing tasks using unconventional methods. Further attributes related to experience may relate to organizational abilities, such as organizing roles for other players.

Personality may be a description of how often a player exhibits certain playing styles or chooses to adopt certain roles. Some aspects related to personality may be heavily influenced by the player's skills and experience, while others may be independent of them. For example, while one skilled and experienced player may choose to battle an opponent alone, another player with comparable skill and experience may choose to do so by collaborating with other players due to a more collaborative personality.

The following examples are provided to demonstrate how a determined behavior (relating to a playing style or adopted role) may be mapped to a predefined attribute (relating to skills, experience, or personality) and the how an attribute value may be determined for the predefined attribute based on the behavior.

For example, a playing style behavior may be used to select and evaluate predefined attributes 514 related to skills and experience. A player with an aggressive playing behavior may perform certain actions more often than a timid playing behavior. In a fighting co-op video game, a player with an aggressive playing behavior may lead to shooting or attacking more often. This may provide more instances of shooting and attacking to be incorporated into the gaming data 520 and may enable more related predefined attribute values to be evaluated. Based on many instances of shooting and attacking, predefined attributes 514 related to agility, dexterity, and accuracy may be evaluated. Since a high repetition of shooting and attacking provides more experience and may lead to better skills, the high repetitions may influence such attribute values to be higher. On the other hand, a timid playing behavior may lead to rarely shooting or attacking with very few skills demonstrated. A low repetition may demonstrate a greater likelihood of a lack of experience and skills and may lead to lower attribute values.

An adopted role behavior may also be used to select and evaluate attributes related to skills and experience. A player adopting the role of leader and/or strategist may be able to perform more actions and decisions that demonstrate high skills and experience, such as devising a complex plan and adapting the plan in response to unexpected events. Related attributes may be precision, creativity, or having high organizational skills. A leader and/or strategist may also devise an ineffective plan, which may lead to a poor performance for all players involved and may lead to a lower attribute value for skills and experience. A player adopting the role of leecher may receive a lower attribute value for attributes related to skills and experience, since the player is more likely to demonstrate such behavior having far fewer skills and less experience. A player adopting the role of saboteur may demonstrate higher skills and experience but may receive an especially high rating in undesirable personality attributes.

Playing style behaviors and adopted roles demonstrated by the player may also correspond to a personality attribute of the player. A player adopting a communicator role may demonstrate an ability to collaborate and communicate with other players to solve a task in the co-op video game. Thus, any attributes related to collaboration, communication, and organization may be assigned a high attribute value. A player adopting a healer role may be assigned a high attribute value for a supportive personality and a player adopting a loner role may be assigned low attribute values related to communication and collaboration.

The above outlined features of the apparatus 500 enable the generation of the dataset 510 for creation of an NPC in the co-op video game. Based on the methods of mapping identifiable behaviors to predefined attributes and determining a corresponding attribute value, the NPC may exhibit behaviors that are comparable to the player character as played by the human player. In comparison to traditional NPCs, which may exhibit predictable behaviors with a small range of actions and decisions, limited dialogue, and limited help, an NPC created based on the dataset 510 may perform more complex actions or make decisions based on a wider range of information, provide dialogue with more valuable information or insight, and respond to unpredictable situations in a way comparable to how the human player may respond.

To enable such complex abilities of the NPC, the mapping of behaviors to attributes and assigning attribute values to those attributes may be derived from more specific forms of gaming data of the player character. In particular, demonstrated behaviors that may be directly observable may often derive from contexts in the co-op video game that are not directly observable. An analysis of behaviors may require an analysis of many forms of data that may have indirectly influenced each other and eventually caused the behavior. Such forms of data and data analysis models capable of processing large amounts of such data will be given in the following with reference to FIG. 5.

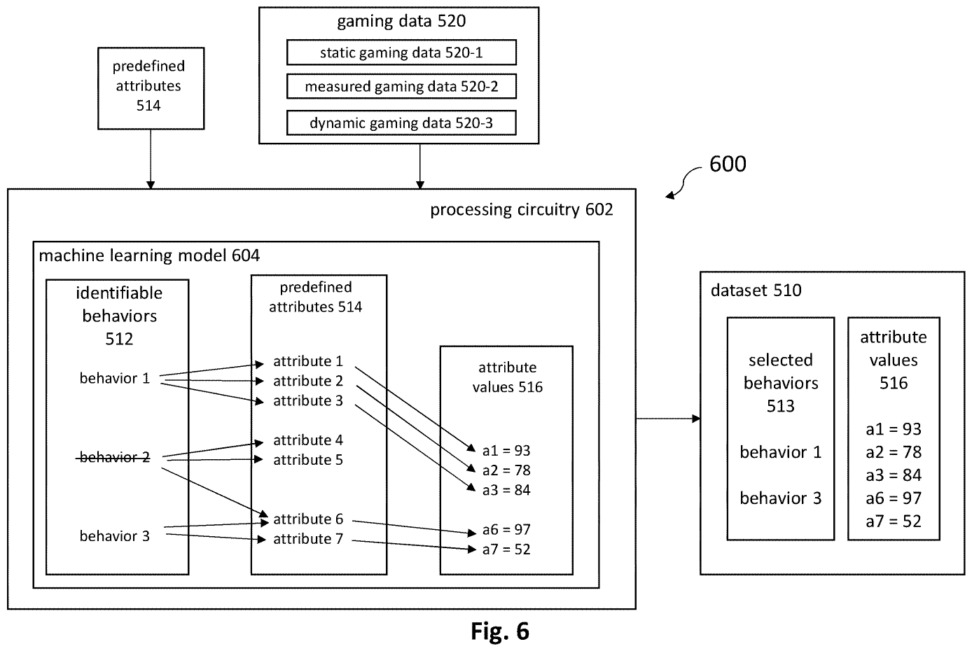

FIG. 6 schematically illustrates another exemplary apparatus for generating a dataset representing a player profile of a human player of a co-op video game.

The following paragraphs explain further embodiments of the apparatus 500 to perform the above outlined functions. For example, for determining the set of attribute values 516 and generating the dataset 510, the processing circuitry 502 may be configured to receive and analyze multiple types of gaming data 520. The gaming data 520 may be in the form of images, videos, text, and/or quantitative data, among other forms. The various forms of gaming data may be analyzed more specifically as static gaming data 520-1, measured gaming data 520-2, and dynamic gaming data 520-3. All forms of the gaming data 520-1; 520-2; 520-3 may be received by the apparatus 500 in a separate or integrated form.

The gaming data 520 in the form of static gaming data 520-1 may describe aspects of the player profile that do not change over time. This may include pre-programmed physical characteristics of the player character, which may relate to factors indirectly influencing playing behaviors, such as appearance and physical stature, as well as directly influential factors, such as strength, speed, or agility (for the player character and not based on abilities of the human player playing with the player character). This may also include other inherent features, such as a pre-specified role for a character based on a pre-programming in a co-op role-playing game. The static gaming data 520-1 may also include any gaming data 520 that is directly readable from a saved file. The saved file may correspond to a saving of character features and accomplishments that maintains a progression in the co-op video game. For example, the saved file may include a character's skill points or experience points gained by progressing through specific levels of a game, which may affect physical or intellectual abilities of the player character. The saved file may include a number of game items possessed by the player character, such as weapons, ammunition, food, potions, etc., over specific periods of time.

The measured gaming data 520-2 may describe actions and decisions of the human player while playing the co-op video game. The measured gaming data 520-2 may include information related to a frequency and duration of movement types of the player character controlled by the human player, such as walking, running, jumping, or crawling. Other movement types may relate to vehicles, including accelerating, braking, driving speed, and driving maneuvers. Other movement types may be related a more specific context of the co-op game, such as actions and decisions related to fighting, shooting, attacking, and defending. Portions of the measured gaming data 520-2 may also relate to the static gaming data 520-1. For example, the measured gaming data 520-2 may describe a frequency of game item usage, such as weapons or spells, and a description of when and how frequently the items are used.

The dynamic gaming data 520-3 may describe a gaming context for the actions and decisions of the measured gaming data 520-2. The dynamic data may comprise data that enables an understanding of context or situations that led to certain actions and decisions. In other words, the measured gaming data 520-2 may provide information on how certain actions were performed, while the dynamic gaming data 520-3 may provide information on why those actions were performed. For example, dynamic gaming data 520-3 may include reasons for why a certain fighting sequence was performed, which may be based on the actions of an opponent, actions of a teammate, abilities of an opponent or teammate, or a plan devised with a teammate before a battle. The dynamic gaming data 520-3 may also be derived from static and measured gaming data related to other characters, either teammates or opponents, particularly while the other characters are interacting with the player character being analyzed. The dynamic gaming data 520-3 may also relate to an environment in which the player character is active, such as a game level with a specific difficulty or an environment in which only specific skills of the player character may be used.

The selection of behaviors from the identifiable behaviors 512 may be made based on the relationships between the various forms of gaming data 520-1; 520-2; 520-3. For example, the behaviors may be identified using the static gaming data 520-1 and measured gaming data 520-2 and an accurate mapping to the predefined attributes 514 and/or determination of attribute values 516 may be achieved with the help of the dynamic gaming data 520-3.

A playing style behavior may be used to select and evaluate predefined attributes 514 related to a personality of the character. For example, if a player exhibits aggressive behavior and demonstrates a high skill level during rare instances of shooting or attacking, then the reason for this may be analyzed in the dynamic gaming data 520-3. This may lead to an evaluation of having high skills and experience with a high rating of a specific personality, such as being cautious or collaborative.

In a further example, a first character may usually exhibit aggressive behavior while a second character may do so only selectively. Here again, the dynamic gaming data 520-3 may provide context to the measured gaming data 520-2. The aggressive behavior may have been for a selected time period or in a planned tank role based on advice communicated by another character. While the first version of aggressive behavior may lead to a high rating in an attribute for an aggressive personality, the second version of aggressive behavior may lead to a high rating for a collaborative personality, among other attributes.

Before determining the behaviors by analysis, certain identifiable behaviors may be pre-mapped to certain predefined attributes 514. For example in FIG. 5, out of three identifiable behaviors 512, a first behavior 1 is mapped to attributes 1, 2, and 3, a second behavior 2 is mapped to attributes 4 and 5, and a third behavior 3 is mapped to attributes 6 and 7. The predefined attributes 514 may also be influenced by a plurality of behaviors. For example, attribute 6 is depicted to correspond to both behavior 2 and behavior 3.

In FIG. 6, the gaming data 520 of the player character is depicted to only demonstrate behavior relating to selected behaviors 513, including behavior 1 and behavior 3. Behavior 2 has been crossed out to depict exclusion of behavior 2 from being assigned attribute values for the dataset 510. For example, a player character may exhibit behavior of adopting a role as a leader. Independent of whether the leader demonstrates proficiency in skills important for leadership, such as communication or organization, the determination of leader behavior may lead to the exclusion of other behavior types. For example, the previously described roles of loner, leecher, and saboteur may be excluded, since these roles are not compatible with a role of leader, even if the leader is not skilled or effective.

The processing circuitry 502 may be configured to only assign an attribute value to the pre-defined attributes 514 corresponding to the identified behaviors, as depicted (with attribute values of 93, 78, 84, 97, and 52 depicted for attributes 1, 2, 3, 6, and 7, respectively). As such, the dataset 510 may comprise the predefined attributes 514 with the corresponding attribute values 516 without information related to other predefined attributes 514. Alternatively, attributes that do not correspond to observed behaviors may be given a rating of zero, “not applicable”, or another similar label, or may be given a low default value. Also, as depicted by attribute 6, attributes that are linked to an excluded behavior may still be given an attribute value by means of another behavior.

In general, the apparatus 500 may be configured to receive various forms of gaming data 520 to determine the set of attribute values 516 for the dataset 510. This may be done by analyzing the gaming data 520 to determine behaviors out of the identifiable behaviors 512, map the identified behaviors to the predefined attributes 514, and assign attribute values 516 to the predefined attributes 514. For this, the processing circuitry 502 may be configured to perform a pattern recognition analysis of the gaming data 520. In particular, to efficiently perform an analysis with many forms of the gaming data 520, embodiments of the processing circuitry 502 may comprise (use) a trained machine-learning model 604 or machine-learning algorithm.

Machine learning may refer to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, a sequence of video frames or images in the gaming data 520 may be analyzed using the machine-learning model 604 or a machine-learning algorithm. This may include analysis of a context between multiple video frames or images, such as how the content of one image may influence the content of a subsequent image in a sequence of images. The analysis of a sequence of images may further include analysis of various static gaming data 520-1, measured gaming data 520-2, and dynamic gaming data 520-3 derived from the contents of a sequence of images.

In order for the machine-learning model 604 to analyze the content in a sequence of images, the machine-learning model 604 may be trained using training sequences of images as input and training content information as output. By training the machine-learning model 604 with a large number of training sequences of images and associated training content information (e.g. labels or annotations), the machine-learning model 604 may “learn” to recognize the content within the images, so the content of images that are not included in the training data can be recognized using the machine-learning model 604.

The machine-learning model 604 may be a supervised machine-learning model, which may be trained using training input data. In supervised learning, the machine-learning model 604 is trained using a plurality of training samples, wherein each sample may comprise a plurality of input data values, and a plurality of desired output values, i.e. each training sample is associated with a desired output value. By specifying both training samples and desired output values, the machine-learning model may 604 “learn” which output value to provide based on an input sample that is similar to the samples provided during the training.

The training data for the machine-learning model 604 may be of the same form as the gaming data 520 to be received for the generation of the dataset 510. For example, the gaming data 520 and training gaming data may be in the form of images, videos, text, and/or quantitative data. In particular, the gaming data 520 and training gaming data may include saved game files, a record of items in possession by the player character, and saved videos of the player character being played in the video game.

For example labeled static gaming data may comprise labels related to all possible items that may be possessed by a character, such as weapons, ammunition, food, and potions, among others. Labeled measured gaming data may comprise labels related to actions of a character. For example, throughout a sequence of images of the character, one or more labels may correspond to a movement type (or lack thereof) of the character. This may be especially useful in fighting sequences, which may include many movement types in a short time frame. Labeled dynamic gaming data may comprise labels related to one or more contexts experienced by the character. For example, a sequence of images may include a label of a virtual environment, a label of level, a label of teammates, a label of opponents, a label of actions taken by the teammates and/or opponents, and a label of skills and experience of the teammates and/or opponents, among others.

The supervised learning may include using labeled training data as previously outlined for the machine-learning model 604 to learn categorizing features of unstructured input data into a predetermined number of identified classes. For example, the machine-learning model 604 may read the static gaming data 520-1 and assign labels to various game items accordingly. It may also perform a pattern recognition analysis on the measured gaming data 520-2 to detect certain movements and assign labels to the detected movements. The analysis may further include determining favorite movement types, fighting styles, favorite weapons, spells, potions, etc. While analyzing the measured gaming data 520-2, the machine-learning model 604 may reference the dynamic gaming data 520-3 to make connections of why certain actions were performed or certain decisions were made. For example, the supervised learning may include monitoring a use of weapons and making connections related to why the weapons were used. Categorizations related thereto may include the weapons used (from the static gaming data 520-1), a frequency of use (from the measured gaming data 520-2), and a context of use (from the dynamic gaming data 520-3).

Apart from supervised learning, semi-supervised learning may be used. In semi-supervised learning, some of the training samples lack a corresponding desired output value. Supervised learning may be based on a supervised learning algorithm (e.g. a classification algorithm, a regression algorithm or a similarity learning algorithm. Classification algorithms may be used when the outputs are restricted to a limited set of values (categorical variables), i.e. the input is classified to one of the limited set of values. Regression algorithms may be used when the outputs may have any numerical value (within a range). Similarity learning algorithms may be similar to both classification and regression algorithms but are based on learning from examples using a similarity function that measures how similar or related two objects are. Apart from supervised or semi-supervised learning, unsupervised learning may be used to train the machine-learning model 604. In unsupervised learning, (only) input data might be supplied and an unsupervised learning algorithm may be used to find structure in the input data (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is another group of machine-learning algorithms. In other words, reinforcement learning may be used to train the machine-learning model 604. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Furthermore, some techniques may be applied to some of the machine-learning algorithms. For example, feature learning may be used. In other words, the machine-learning model 604 may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

In some examples, anomaly detection (i.e. outlier detection) may be used, which is aimed at providing an identification of input values that raise suspicions by differing significantly from the majority of input or training data. In other words, the machine-learning model 604 may at least partially be trained using anomaly detection, and/or the machine-learning algorithm may comprise an anomaly detection component.

Association rules are a further technique that may be used in machine-learning algorithms. In other words, the machine-learning model 604 may be based on one or more association rules. Association rules are created by identifying relationships between variables in large amounts of data. The machine-learning algorithm may identify and/or utilize one or more relational rules that represent the knowledge that is derived from the data. The rules may e.g. be used to store, manipulate or apply the knowledge.

In general, machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge (e.g. based on the training performed by the machine-learning algorithm). In embodiments, the usage of a machine-learning algorithm may imply the usage of an underlying machine-learning model (or of a plurality of underlying machine-learning models). The usage of a machine-learning model may imply that the machine-learning model 604 and/or the data structure/set of rules that is the machine-learning model 604 is trained by a machine-learning algorithm.

For example, the machine-learning model 604 may be an artificial neural network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of its inputs (e.g. of the sum of its inputs). The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e. to achieve a desired output for a given input.

The machine-learning model 604 may comprise a deep neural network with multiple layers between the input and output nodes. More specifically, the machine-learning model 604 may comprise a convolutional neural network (CNN), which may have the ability to learn and recognize complex patterns in sequences of images. The CNN may be configured to perform recognition of objects, environments, characters with associated physical features, movements, and playing contexts, among other things related to the gaming data 520. The CNN may comprise multiple layers, including convolutional layers, pooling layers, and fully connected layers. In the convolutional layers, filters may be applied to an input image to detect and extract features, such as edges, lines, and shapes. The pooling layers may reduce the size of data by selecting the most prominent features in the input image. The fully connected layers may then combine the extracted features.

The machine-learning model 604 may also comprise a recurrent neural network (RNN), which may be used for sequence analysis. The RNN may be used for pattern recognition within sequential images or video frames and capturing temporal dependencies. The RNN may process one image or video frame in a sequence while maintaining temporal information, which may then be used to generate a prediction for the next image or video frame. By processing each frame in a sequence to predict the next frame, the RNN can learn to recognize patterns and regularities, particularly related to objects, movements, and playing contexts of the gaming data 520.

The machine-learning model 604 may include a decision tree model. Decision tree models can be used for pattern recognition in image sequences or videos by considering data points within each image or frame, as well as temporal relationships between consecutive images or frames. Decision tree models may be used for tasks related to classification of data within the gaming data 520. The decision tree model may include splitting the gaming data 520 into subsets based on values of features toward creating homogenous subsets for a target variable, such as a specific item, movement, or context. The splitting of data may continue until a stopping criterion is met.

Alternatively, the machine-learning model 604 may be a support vector machine, a random forest model or a gradient boosting model. Support vector machines (i.e. support vector networks) are supervised learning models with associated learning algorithms that may be used to analyze data (e.g. in classification or regression analysis). Support vector machines may be trained by providing an input with a plurality of training input values that belong to one of two categories. The support vector machine may be trained to assign a new input value to one of the two categories. Alternatively, the machine-learning model 604 may be a Bayesian network, which is a probabilistic directed acyclic graphical model. A Bayesian network may represent a set of random variables and their conditional dependencies using a directed acyclic graph. Alternatively, the machine-learning model 604 may be based on a genetic algorithm, which is a search algorithm and heuristic technique that mimics the process of natural selection.

The processing circuitry 502 may be configured to use one or more of the above described features of the trained machine-learning model 604 to perform a pattern recognition analysis of the gaming data 520. Based on a training by the labeled gaming data, the machine-learning model 604 may be configured to receive the gaming data 520 and organize detected items, movements, and contexts into categories for the gaming data 520. The machine-learning model 604 may receive the gaming data 520 in an unstructured or unlabeled form as input data, provide structure or labels by performing the pattern recognition analysis, and generate an output with structure and labels.

The pattern recognition analysis may further include identifying trends and regularities in the gaming data 520. In particular, the pattern recognition analysis may include searching the static gaming data 520-1, measured gaming data 520-2, and dynamic gaming data 520-3 for the trends and regularities and determine the identifiable behaviors of the player, as previously outlined. The machine-learning model 604 may further determine the affected pre-defined attributes 514 and corresponding attribute values 516 using one or more of the features outlined above. By assigning at least a portion of the predefined attributes 514 to an attribute value 516, the characteristics of a new player character may be defined.

Once the set of attribute values 516 has been determined, the dataset 510 comprising the set of attribute values 516 may be generated. The processing circuitry 502 is configured to generate the dataset 510 to include the determined set of attribute values 516 based on the gaming data 520 derived from the actions and decisions of the human player. The dataset 510 may then be exported to other devices or networks to be used by other players.

The apparatus 500; 600 of FIGS. 5 and 6 comprises features enabling the generation of datasets 510 for the creation of NPCs, particularly with distinguishable human-like playing behaviors. The datasets may then be bought and sold in connection with minted NFTs, which may provide an incentive for the generation of such datasets. The apparatus 100; 200; 300 for creating the NPC within the co-op video game provides complementary features to the apparatus 500; 600 for generating the dataset 510. In one embodiment of the apparatus 300 for creating the NPC 120, the dataset 110 may be accessible on the condition of ownership verification. Embodiments of the apparatus 100; 200; 300 may also comprise the GUI 210; 310 that may enable an ease of use for exchanging NFTs, finding a dataset 110 for a player profile with desired behaviors, accessing the dataset 110 of an NFT, and/or modifying attributes of an NPC after importation of the dataset 110.

The features of all described apparatuses 100; 200; 300; 400; 500 may be provided by a single apparatus or separate apparatuses. Players of the co-op video game may then both generate a dataset 510 based on their own playing behaviors, as well as obtain a dataset 110 based on other human-like playing behaviors. Some embodiments enable finding many such datasets for testing many different co-op NPCs, each with distinguishable behaviors. In general, the embodiments provided may provide a vastly different and more modernized co-op gaming experience for the user.

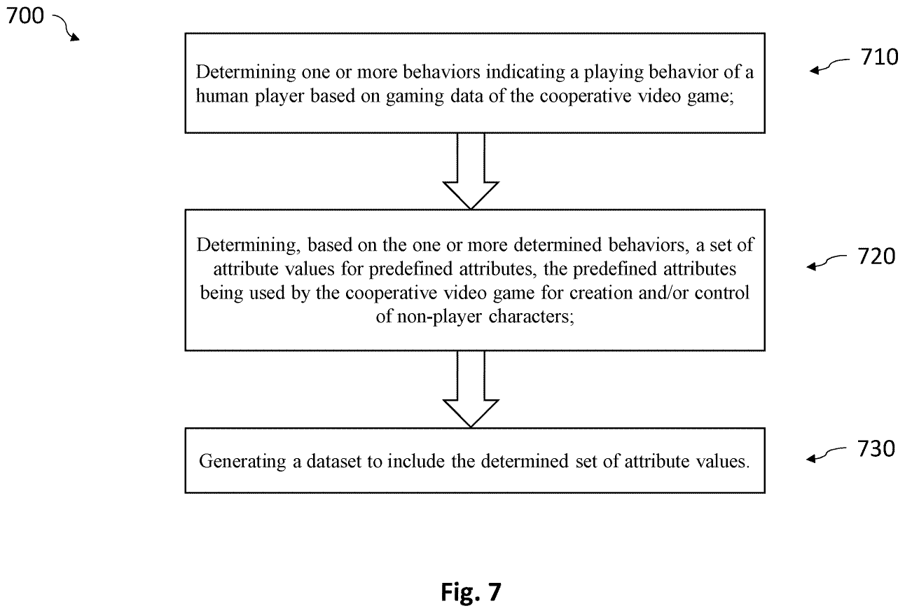

FIG. 7 illustrates a flowchart of an exemplary method 700 for generating a dataset representing a player profile of a human player of a co-op video game.

The method 700 comprises determining 710 one or more behaviors indicating a playing behavior of the human player based on gaming data of the co-op video game. The method 700 further comprises determining 720, based on the one or more determined behaviors, a set of attribute values for predefined attributes. The predefined attributes are used by the co-op video game for creation and/or control of NPCs. In addition, the method 700 comprises generating 730 a dataset to include the determined set of attribute values. The method 700 may optionally comprise one or more further features described above (e.g. FIG. 6).

The above outlined features of the method 700 may enable the generation of the dataset 510 for creation of an NPC in the co-op video game. The NPC may exhibit behaviors that are comparable to the player character as played by the human player. In comparison to traditional NPCs, an NPC created based on the dataset 510 may perform more complex actions or make decisions based on a wider range of information, provide dialogue with more valuable information or insight, and respond to unpredictable situations in a way comparable to how the human player may respond. In particular, the methods 400; 700 making use of the features of the described apparatuses 100; 400 may complement each other to provide an NPC with advanced behaviors comparable to a player character as played by a human player. The optional features for the methods applying further embodiments of the apparatuses 200; 300; 600 may enable further improving and enhancing the user's co-op gaming experience related to advanced NPCs and obtaining and testing many versions of advanced NPCs.

The following examples pertain to further embodiments:
(1) A method for creating a non-player character, NPC, in a cooperative video game, the method comprising: accessing, based on a user input of a user, a dataset representing a player profile of a human player of the cooperative video game, the player profile including a set of attribute values indicating a playing behavior of the human player; and creating the NPC based on the set of attribute values.
(2) The method of (1), the method further comprising causing output of a graphical user interface allowing the user to specify the dataset.
(3) The method of (2), wherein the graphical user interface allows the user to specify a non-fungible token, NFT, for the dataset representing the player profile, and wherein the user input indicates an NFT for the player profile.
(4) The method of (2), wherein the graphical user interface allows the user to select one or more desired behaviors of the NPC, and wherein the method further comprises receiving one or more further user inputs for selecting one or more desired behaviors of the NPC; and controlling, based on the selected desired behaviors of the NPC, the graphical user interface to present one or more selectable player profiles of human players, wherein the user input specifies one of the one or more selectable player profiles of human players.
(5) The method of (4), further comprising controlling the graphical user interface to present one or more graphical elements enabling the user to acquire an NFT for the player profile specified by the user input.
(6) The method of (3) or (5), wherein the NFT comprises storage information indicating a storage location of the dataset, and wherein accessing the dataset comprises: accessing the storage location of the dataset based on the storage information; and reading the dataset from the storage location.
(7) The method of (6), wherein the NFT further comprises ownership information indicating an owner of the dataset, and wherein accessing the dataset comprises: verifying whether the user owns the dataset based on the ownership information; and reading the dataset from the storage location only if it is verified that the user owns the dataset.
(8) The method of any one of (1) to (7), further comprising causing output of a graphical user interface comprising one or more graphical elements allowing the user to modify one or more attribute values of the set of attribute values; and obtaining a modified set of attribute values by modifying one or more attribute values of the set of attribute values based on one or more further user inputs of the user, wherein creating the non-player character comprises creating the non-player character based on the modified set of attribute values.
(9) The method of any one of (1) to (8), further comprising causing the video game to control the NPC based on the set of attribute values.
(10) A method for generating a dataset representing a player profile of a human player of a cooperative video game, the method comprising determining one or more behaviors indicating a playing behavior of the human player based on gaming data of the cooperative video game; determining, based on the one or more determined behaviors, a set of attribute values for predefined attributes, the predefined attributes being used by the cooperative video game for creation and/or control of non-player characters; and generating the dataset to include the determined set of attribute values.

(11) The method of (10), wherein determining the one or more behaviors indicating the playing behavior of the human player comprises: identifying, based on the gaming data of the cooperative video game, one or more behaviors of a plurality of identifiable behaviors as the one or more behaviors indicating the playing behavior of the human player.

(12) The method of (11), wherein a trained machine-learning model is used for identifying one or more behaviors of the plurality of identifiable behaviors as the one or more behaviors indicating the playing behavior of the human player, and wherein the trained machine-learning model receives the gaming data as input.
(13) The method of (12), wherein the trained machine-learning model identifies one or more behaviors of the plurality of identifiable behaviors as the one or more behaviors indicating the playing behavior of the human player through pattern recognition processing on the gaming data.
(14) The method of any one of (10) to (13), wherein determining the set of attribute values for the predefined attributes comprises determining, based on the one or more determined behaviors, one or more attributes of the predefined attributes which are affected by the respective determined behavior; and determining, based on the respective determined behavior, a respective attribute value for the one or more attributes of the predefined attributes affected by the respective determined behavior.
(15). The method of (14), wherein a trained machine-learning model is used for determining the set of attribute values for the predefined attributes, and wherein the trained machine-learning model receives the one or more determined behaviors as input.
(16) The method of any one of (10) to (15), wherein the gaming data comprises at least one of static gaming data describing aspects of the player profile which do not change over time and/or are readable from a saved file, measured gaming data describing actions of the human player in the cooperative video game as the cooperative video game is played by the human player, and dynamic gaming data describing a gaming context for the actions of the human player in the cooperative video.
(17) An apparatus for creating a non-player character, NPC, in a cooperative video game, the apparatus comprising processing circuitry configured to: access, based on a user input of a user, a dataset representing a player profile of a human player of the cooperative video game, the player profile including a set of attribute values indicating a playing behavior of the human player; and create the NPC based on the set of attribute values.
(18) An apparatus for generating a dataset representing a player profile of a human player of a cooperative video game, the apparatus comprising processing circuitry configured to: determine one or more behaviors indicating a playing behavior of the human player based on gaming data of the cooperative video game; determine, based on the one or more determined behaviors, a set of attribute values for predefined attributes, the predefined attributes being used by the cooperative video game for creation and/or control of non-player characters; and generate the dataset to include the determined set of attribute values.
(19) A program having a program code for performing the method according to any one of (1) to (16), when the program is executed on a processor or a programmable hardware.
(20) A non-transitory machine-readable medium having stored thereon a program having a program code for performing the method according to any one of (1) to (16), when the program is executed on a processor or a programmable hardware.

The aspects and features described in relation to a particular one of the previous examples may also be combined with one or more of the further examples to replace an identical or similar feature of that further example or to additionally introduce the features into the further example.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A method for creating a non-player character, NPC, in a cooperative video game, the method comprising:
accessing, based on a user input of a user, a dataset representing a player profile of a human player of the cooperative video game, the player profile including a set of attribute values indicating a playing behavior of the human player; and
creating the NPC based on the set of attribute values.

2. The method of claim 1, the method further comprising:
causing output of a graphical user interface allowing the user to specify the dataset.

3. The method of claim 2, wherein the graphical user interface allows the user to specify a non-fungible token, NFT, for the dataset representing the player profile, and wherein the user input indicates an NFT for the player profile.

4. The method of claim 2, wherein the graphical user interface allows the user to select one or more desired behaviors of the NPC, and wherein the method further comprises:
receiving one or more further user inputs for selecting one or more desired behaviors of the NPC; and
controlling, based on the selected desired behaviors of the NPC, the graphical user interface to present one or more selectable player profiles of human players,
wherein the user input specifies one of the one or more selectable player profiles of human players.

5. The method of claim 4, further comprising:
controlling the graphical user interface to present one or more graphical elements enabling the user to acquire an NFT for the player profile specified by the user input.

6. The method of claim 3, wherein the NFT comprises storage information indicating a storage location of the dataset, and wherein accessing the dataset comprises:
accessing the storage location of the dataset based on the storage information; and
reading the dataset from the storage location.

7. The method of claim 6, wherein the NFT further comprises ownership information indicating an owner of the dataset, and wherein accessing the dataset comprises:
verifying whether the user owns the dataset based on the ownership information; and
reading the dataset from the storage location only if it is verified that the user owns the dataset.

8. The method of claim 1, further comprising:
causing output of a graphical user interface comprising one or more graphical elements allowing the user to modify one or more attribute values of the set of attribute values; and
obtaining a modified set of attribute values by modifying one or more attribute values of the set of attribute values based on one or more further user inputs of the user,
wherein creating the non-player character comprises creating the non-player character based on the modified set of attribute values.

9. The method of claim 1, further comprising:
causing the video game to control the NPC based on the set of attribute values.

10. A method for generating a dataset representing a player profile of a human player of a cooperative video game, the method comprising:
determining one or more behaviors indicating a playing behavior of the human player based on gaming data of the cooperative video game;
determining, based on the one or more determined behaviors, a set of attribute values for predefined attributes, the predefined attributes being used by the cooperative video game for creation and/or control of non-player characters; and
generating the dataset to include the determined set of attribute values.

11. The method of claim 10, wherein determining the one or more behaviors indicating the playing behavior of the human player comprises:
identifying, based on the gaming data of the cooperative video game, one or more behaviors of a plurality of identifiable behaviors as the one or more behaviors indicating the playing behavior of the human player.

12. The method of claim 11, wherein a trained machine-learning model is used for identifying one or more behaviors of the plurality of identifiable behaviors as the one or more behaviors indicating the playing behavior of the human player, and wherein the trained machine-learning model receives the gaming data as input.

13. The method of claim 12, wherein the trained machine-learning model identifies one or more behaviors of the plurality of identifiable behaviors as the one or more behaviors indicating the playing behavior of the human player through pattern recognition processing on the gaming data.

14. The method of claim 10, wherein determining the set of attribute values for the pre-defined attributes comprises:
determining, based on the one or more determined behaviors, one or more attributes of the predefined attributes which are affected by the respective determined behavior; and
determining, based on the respective determined behavior, a respective attribute value for the one or more attributes of the predefined attributes affected by the respective determined behavior.

15. The method of claim 14, wherein a trained machine-learning model is used for determining the set of attribute values for the predefined attributes, and wherein the trained machine-learning model receives the one or more determined behaviors as input.

16. The method of claim 10, wherein the gaming data comprises at least one of static gaming data describing aspects of the player profile which do not change over time and/or are readable from a saved file, measured gaming data describing actions of the human player in the cooperative video game as the cooperative video game is played by the human player, and dynamic gaming data describing a gaming context for the actions of the human player in the cooperative video.

17. An apparatus for creating a non-player character, NPC, in a cooperative video game, the apparatus comprising processing circuitry configured to:
access, based on a user input of a user, a dataset representing a player profile of a human player of the cooperative video game, the player profile including a set of attribute values indicating a playing behavior of the human player; and
create the NPC based on the set of attribute values.

18. An apparatus for generating a dataset representing a player profile of a human player of a cooperative video game, the apparatus comprising processing circuitry configured to:
determine one or more behaviors indicating a playing behavior of the human player based on gaming data of the cooperative video game;
determine, based on the one or more determined behaviors, a set of attribute values for pre-defined attributes, the predefined attributes being used by the cooperative video game for creation and/or control of non-player characters; and
generate the dataset to include the determined set of attribute values.

19. A program having a program code for performing the method according to claim 1, when the program is executed on a processor or a programmable hardware.

20. A non-transitory machine-readable medium having stored thereon a program having a program code for performing the method according to claim 1, when the program is executed on a processor or a programmable hardware.
